(19) United States
(12) Patent Application Publication
(10) Pub. No.: US 2008/0084097 A1
(43) Pub. Date: Apr. 10, 2008

(54) SUPPORT FOR A BACKREST

(76) Inventor: David Ian Botting, Leicester (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/669,437

(22) Filed: Jan. 31, 2007

(30) Foreign Application Priority Data
Oct. 6, 2006 (GB) 0619898.0

(51) Int. Cl. B62J 1/00

(52) U.S. Cl. 297/215.12

(57) ABSTRACT

A support (10) for a backrest for a saddle-type seat (50) includes a pad mounting (11) secured to an in-use erect stem member (12) a part of which is, at a pivot location (18) remote from the pad mounting, pivotably secured to an indexing mount (19). The latter supports a cam (29) that is moveably engageable with the stem member (12), movement of the cam determining the part thereof that engages the stem member in order to cause the stem member (12) and the indexing mount to pivot one relative to the other in adjustment of their relative translational positions.

### BACKGROUND OF THE INVENTION

This invention relates to a support for a backrest for a saddle-type seat.

### DESCRIPTION OF PRIOR ART

Such seats predominantly are encountered in vehicles such as motorcycles and quad-bikes, in which the invention primarily finds application. Saddle-type seats however also commonly are used in amusement park rides and in vehicles such as Jetskis, motorised toboggans exemplified by the “Skidoo”, and bicycles. The scope of the invention extends to supports for use in all such vehicles.

Especially in certain types of motorcycle there is a need to provide a backrest support in a saddle-type seat. Such motorcycles usually are known as “cruiser” models, on which a rider sits more upright than is the case in sports motorcycles.

Cruiser motorcycles are intended to permit a rider to travel in comfort continuously for long distances. To this end it is known to provide a backrest that protrudes upwardly from the middle part or the rear of the saddle of the vehicle. The backrest lets the rider relax the muscles in the arms and the lower back, by supporting the lower back on the backrest, thereby reducing the risk of fatigue that would result from straining the various muscles over long periods.

It is strongly desirable for the backrests to be adjustable in terms of rake (i.e. a fore-and-aft adjustment relative to the front and rear of the vehicle); height of a padded member, forming part of the backrest and that engages the lower back of the rider, relative to the seat; and tilt angle of the backrest relative to the essentially horizontal, padded seat part that is typical in such seats.

Also it is desirable for a backrest to be installable either as an “after-market” accessory or as a “factory fit” item. To this end it is known to provide a mounting point for a backrest in the form of e.g. a metal plate secured to the padded seat part to permit screwing or other fastening thereto of a backrest support.

It is known to provide an adjuster for a saddle backrest support in the form of a rotatable screw by means of which the backrest support may be driven forwardly and rearwardly relative to the remainder of the vehicle seat.

The known designs provide either continuous or step-wise adjustment of the fore-and-aft position of the backrest support, depending on the precise design adopted.

In the arrangements offering continuous adjustment precise setting of the backrest position is difficult.

The designs offering step-wise adjustment rely on the provision of screws of differing lengths in a kit including the backrest support, or a multi-position bracket having a series of mounting holes. In order to adjust the position of the support in such arrangements it is necessary largely or completely to de-mount or even dismantle the backrest mechanism.

Certain designs of support known in the art in any event do not readily lend themselves to manufacture as discrete items that may be fitted as after-market accessories yet which offer ease of adjustment and accurate, step-wise operation. An aim therefore of the invention is to overcome at least one of these disadvantages of the prior art devices.

### BRIEF DESCRIPTION OF THE INVENTION

According to the invention in a broad aspect there is provided a support for a backrest for a saddle-type seat, the support comprising a pad mounting secured to an in-use erect stem member a part of which is, at a pivot location remote from the pad mounting, pivotably secured to an indexing mount supporting a cam that is moveably engageable with the stem member, movement of the cam determining the part thereof that engages the stem member in order to cause the stem member and the indexing mount to pivot one relative to the other at the pivot location in adjustment of their relative translational positions.

Such an arrangement advantageously may be manufactured as a discrete after-market accessory whose functional parts are independent of the parts of the seat with which it is intended to be used. As a result it is necessary for the vehicle seat only to include a mounting plate or recess to which the support may be secured e.g. using screws or bolts in order to accommodate the support. This in turn means that the backrest support is useable with a range of different types of seat and hence is highly suited to supply as an after-market accessory.

The inclusion of a cam and the pivoting mounting of the stem member relative to the indexing mount means that the support readily lends itself to easy adjustment, through the use of features described in more detail below, after installation. Furthermore step-wise operation is facilitated. Specific features promoting effective step-wise operation are described below.

Preferably the support includes a resiliently deformable biaser urging the stem member in a direction of movement that is opposed by engagement of the cam with the stem member.

Such an arrangement assures positive engagement between the cam and the stem member thereby providing a robust arrangement that provides reassuring support for a user.

In more detail, a support according to the invention preferably includes a pivot bar, which protrudes from the stem member in order to define the pivot location, secured to the indexing mount and defining an axis about which the stem member pivots relative to the indexing mount, the resiliently deformable biaser including a spring that interconnects the stem member and the indexing mount so as resiliently to bias the stem member and the indexing mount one relative to the other.

Such an arrangement is reliable in use and is advantageously cheap, quick and simple to manufacture.

Ease and economy of manufacture are of particular importance when considering after-market accessories, and the arrangement of the invention provides strong benefits in this regard.

In an especially favourable aspect the cam of the support optionally includes an exterior having formed thereon a series of flats separated from one another by edges.

The provision of the series of flats assists in providing an arrangement that permits step-wise adjustment of the position of the support member and hence of any backrest secured thereto.

It is particularly beneficial in this regard that in one embodiment of the invention the cam is rotatably secured to the indexing mount. This permits “indexing” of the cam relative to the stem member in order to present selected flats, in turn, for engagement with the stem member and thereby provide a chosen degree of adjustment of the position of the stem member.

More particularly the axis of pivoting of the stem member is chosen such that on pivoting the stem member moves forwardly and rearwardly relative to the front and rear ends of the seat to which it is, in use, secured. Thus the arrangement of the invention in a simple fashion provides for ready fore-and-aft adjustment of the support.

Conveniently the support includes a camshaft having secured thereto the cam, the camshaft permitting rotatable securing of the cam to the indexing mount.

A camshaft is of course known per se. The use of a camshaft in conjunction with a multi-faceted cam as defined hereinabove is believed to be unique in the backrest support art in providing a reliable adjustment means that is simple to operate.

Preferably the camshaft has secured thereto an actuator member for moving the cam. It is further preferable that the actuator member protrudes beyond the extent of the indexing mount; and is or includes a rotatable handwheel.

The foregoing features conveniently provide an easy-to-operate adjustment mechanism. Such an arrangement is particularly advantageous in the case of a support for a motorcycle backrest, since users wishing to adjust the backrest may suffer from a lack of dexterity either as a result of wearing protective gloves or as a result of having cold hands.

Preferably the support includes a resiliently deformable actuator biaser acting between the actuator and the indexing mount tending to urge the actuator towards a predetermined position; and the actuator includes a detent arrangement that reacts pressure from the actuator biaser to provide surmountable resistance to movement of the actuator.

Such an arrangement advantageously allows operation of the actuator member (typically a handwheel, as aforesaid) in an “indexible” fashion in which the indexing positions of the handwheel correspond to engagement of respective flats of the cam with the stem member. This is an advantageously simple yet positive arrangement that promotes quick and easy adjustment of the backrest position.

In a preferred embodiment the stem member includes two parts that are moveably secured one to the other such that the length of the stem member is adjustable.

More specifically, the stem member includes two sub-members that are slideably engageable one with the other.

Even more specifically one of the sub-members preferably includes formed therein a slot and the other includes an aperture for receiving a bolt, the bolt being capable of passing thorough the slot and receiving a nut on the side thereof remote from the aperture, for fastening the sub-members together at a chosen position of the bolt relative to the slot.

The foregoing features provide a simple, reliable means of adjusting the length of the stem member. As a result in use of the support of the invention it is possible readily to adjust the height of a backrest pad secured to the stem member relative to the vehicle seat.

In this regard the invention is additionally considered to reside in a backrest support as defined hereinabove, including secured thereto a backrest. Typically such a backrest may be a padded member having a rigid frame a part of which is directly securable (for example through the use of fastenings such as screws) to the stem member. However, other designs of backrest (such as, for example, moulded foam backrests or even rigid members made of metal or other rigid materials) are possible within the scope of the invention.

The scope of the invention extends to a vehicle seat having secured thereto a support as defined hereinabove. In such an arrangement the indexing member may be fastened, through the employment of appropriate fastening means such as screws, to a rigid plate set into the rearmost portion of the seat; or in a recess or aperture formed e.g. mid-way along a two-rider seat. In either case if the support includes an actuator member as aforesaid protruding beyond the extent of the indexing mount adjustment of the stem member in the fore-and-aft directions is easily achievable.

### BRIEF DESCRIPTION OF THE DRAWINGS

There now follows a description of preferred embodiments of the invention, by way of non-limiting example, with reference being made to the accompanying drawings in which:

FIG. 1 is a perspective view, taken from the rear, of a support, for a backrest for a saddle-type seat, in accordance with the invention;

FIG. 2 is an exploded, perspective view, taken from the front, of the FIG. 1 support showing the various parts thereof in a disassembled condition;

FIG. 3 is a perspective, partially exploded view showing one form of mounting of the support of FIGS. 1 and 2 to a saddle-type seat of a cruiser motorcycle; and

FIG. 4 is a perspective view of the support of FIGS. 1 to 3 in an in-use condition.

### DETAILED DESCRIPTION OF THE INVENTION

Referring to the drawings, a support 10 comprises a pad mounting 11 in the form of a generally flat, metal plate made e.g. from mild steel and in the embodiment shown having a shape resembling a trapezium whose corners are rounded. Other shapes of the plate are possible within the scope of the invention.

The mounting 11, the function of which is described in more detail hereinbelow, is secured to the upper end of an in-use erect stem member 12.

Securing of the pad mounting 11 is by way of a pair of ears 13 that protrude forwardly of it on either side of a rectangular recess 14 extending from the lowermost edge of the pad mounting 11 towards the centre thereof.

The shape and size of the recess 14 are approximately complementary with the shape of the upper end of the stem member 12 which has the profile of a rectangular channel-section.

At its uppermost end stem member 12 is formed with a further pair of ears 16 (FIG. 2) such that the ears 13 and 16 may on assembly of the support 10 be placed in register with one another.

Each of the ears 13, 16 is perforated by a through-going hole 17 through which one or more nut and bolt combinations 11a may be inserted in a conventional manner in order to secure the pad mounting 11 on the upper end of the stem member 12.

The use of such an arrangement for securing the pad mounting 11 permits adjustment of the angle of tilt of the pad mounting 11 relative to the stem member 12. In the preferred embodiment shown the nut and bolt combination 11a are set to a predetermined torque such that there is limited, frictional resistance to adjustment of the pad mounting angle. This permits adjustment of the angle when a rider presses his back into it. In an alternative set-up the backrest pad mounting angle may be rigidly fixed. It may be adjusted under such circumstances through a process of slackening the nut and bolt combination 11a, adjusting the tilt angle and subsequently tightening the nut and bolt.

The pad mounting 11 is shown at the in-use free upper end of the stem member 12. In other embodiments of the invention this need not necessarily be so, although the provision of the pad mounting at this location permits pivoting of the pad mounting 11 over a useful range of angular adjustment since there is no danger of the pad mounting 11 fouling on the stem member 12.

At its lowermost end opposite the ears 16 stem member 12 is formed as a pivot location 18 at which the stem member 12 is pivotably secured to an indexing mount 19.

In the embodiment shown in the drawings the pivot location lies approximately at the opposite, free end of stem member 12 to that at which pad mounting 11 is secured. However, this need not necessarily be so as the pivot location could in other embodiments lie part-way along the stem member 12.

Pivot location 18 is defined by a further pair of perforated ears 21 protruding in an in-use forward direction from the lowermost end of the rectangular channel-section of stem member 12.

As a result the ears are spaced from one another by the width of the stem member 12 in the vicinity of pivot location 18.

Each of the ears 21 is perforated by a through-going circular aperture 22. Since in preferred embodiments the stem member 12 is also formed from a metal such as mild steel it is easy to fabricate the ears, 16, 21 and the apertures 17, 22 through simple pressing and folding operations.

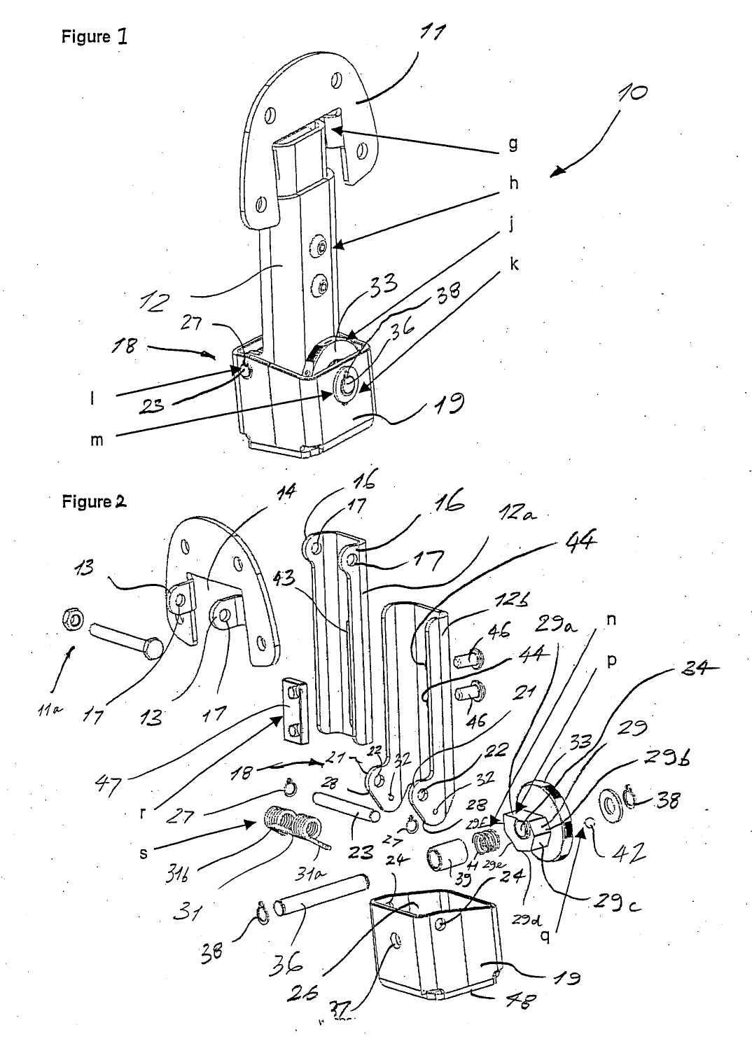

A pivot bar 23 is inserted through and interconnects the apertures 22. Indexing mount 19 is as shown in FIGS. 1 and 2 a hollow cuboid (that may also readily be fabricated from a metal such as mild steel) having a pair of through-going pivot bar apertures 24 formed on opposite sides, adjacent the upper edges of two of its walls.

In this vicinity the indexing mount 19 is defined as an open-ended cuboid such that the in use lowermost end of the stem member 12 is insertable via an open, upper end 26.

The length of pivot bar 23 is such that its ends are receivable via the apertures 24 to protrude as is visible in FIG. 1 on the exterior of indexing mount 19 on either side thereof. A respective circlip or similar fastening 27 is secured on the resulting, protruding end of pivot bar 23 on either side of the exterior of indexing mount 19. As a result the lowermost end of stem member 12 is retained pivotably captive relative to indexing mount 19 in such a way as to protrude via the open end 26 thereof.

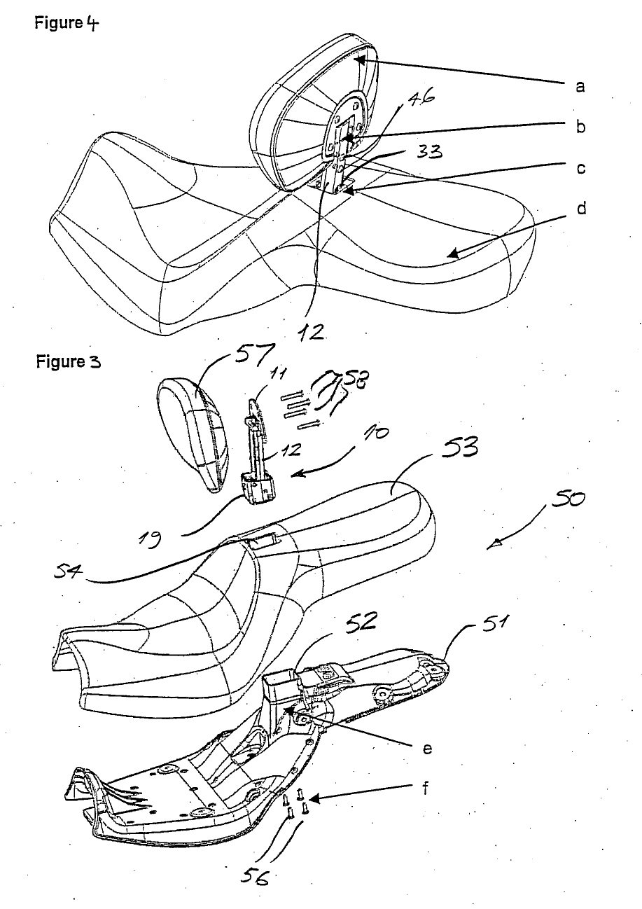

The shape of the ears 21, being provided with an inclined undercut 28, permits pivoting of the stem member 12 between a position lying substantially at right angles to the orientation shown in the drawings, so that the stem member 12 extends generally forwardly (when judged with reference to the forward and rear ends of e.g. a motorcycle) relative to the indexing mount 19; and an upright position in which it is vertical or (as shown in FIGS. 1 and 4) tilted rearwardly relative to indexing mount 19. Among other things this feature assists a rider to negotiate the backrest when getting onto and off the vehicle.

The indexing mount additionally supports a cam 29 for movement (in the preferred embodiment, rotation) relative to the indexing mount 19 and stem member 12. Cam 29 is mounted, in a manner described below, so as to engage a lower edge of stem member 12 located rearwardly of the ears 21. As a result the pivot angle of the stem member 12 may be adjusted by reason of being supported at differing heights depending on the height of the part of cam 29 for the time being engaged therewith. Since as described above the stem member 12 is pivotable about an axis defined by pivot bar 23 extending from side to side relative to the indexing mount 19, movement of the cam 29 causes fore-and-aft adjustment of the position of the stem member 12 and hence of the pad mounting 11.

Positive engagement of the stem member 12 with the cam 29 is assured through the use of a resilient biasser in the form of torsion spring 31.

In the precise embodiment shown torsion spring 31 includes a hollow interior and as a result is fitted over pivot bar 23. At a location spaced from apertures 22 stem member 12 is on each side of its channel shape further perforated by small apertures 32.

Torsion spring 31 is in the embodiment shown wound from a spring wire the free ends 31a of which are shaped as appropriate and received in the small apertures 32.

In use of the support of the invention one or more further, protruding parts 31b of torsion spring 31 bear against e.g. a wall member of indexing mount 19 the whole arrangement being such as to provide resilient resistance to pivoting of the stem member 12 in the forward direction as defined hereinabove. As a consequence stem member 12 is permanently urged into contact with cam 29, regardless of the height of the part of cam 29 for the time being in contact with stem member 12. Thus the stem member and the indexing mount are resiliently biased one relative to the other.

As is best seen in FIG. 2, cam 29 is defined as a boss protruding from a handwheel 33. The boss defining cam 29 is formed as a series of flats 29a, 29b, etc arrayed around a central bore 34 extending through the boss and the handwheel 33.

The flats 29a, 29b, etc are separated from one another by a series of edges as is evident from FIG. 2. The flats represent cam surfaces whose heights relative to the bore 34 are different from one another. If as is described below the handwheel 33 is rotatably mounted relative to the indexing mount 19 it is possible to effect engagement of one of the flats 29a, 29b, etc at a time with the stem member 12 and thereby selectively adjust the position of the pad mount 11 as aforesaid.

Handwheel 33 serves as an actuator member for causing selective (i.e. user-initiated) rotation of the cam 29. Rotatable mounting of the cam 29 and the handwheel 33 secured thereto is achieved through the use of a camshaft 36 that extends from one side of indexing mount 19 to the other and is received at either end in a through-going aperture 37 formed in respective, opposite walls of indexing mount 19.

Camshaft 36 extends through bore 34 and as a result handwheel 33 and cam 29 are retained rotatably captive relative to indexing mount 19.

Camshaft 36 protrudes from the external surfaces of indexing mount 19 at opposite ends thereof. A respective circlip or similar fastening 38 effects retention of camshaft 36 at each end in a permanent manner relative to indexing mount 19. As needed the circlips 38 may be provided in conjunction with one or more washers as shown.

The length of bore 34 is somewhat less than the length of camshaft 36 lying inside the hollow interior of indexing mount 19. A hollow sleeve 39 encircles camshaft 36 in the space between cam 29 and the opposite wall of indexing mount 19. A compression spring 41 also encircles camshaft 36 so as to bear at one end against an end of hollow sleeve 39 and at the other end against the cam 29. The resiliently deformable nature of compression spring 41 as a result urges handwheel 33 towards the in-use rear end of indexing mount 19.

Although not visible in the drawings, the rear face of handwheel 33 is formed with a series of depressions corresponding in number and location to the flats 29a, 29b, etc of cam 29. A detent ball 42 is, as a result of pressure exerted by compression spring 41, retained captive between handwheel 33 and the adjacent wall of indexing mount 19. The arrangement is such as to provide surmountable resistance to rotation of handwheel 33 and thereby define a positively selectable indexing arrangement. The indexing mount wall and the handwheel may include such formations as are needed to promote retention of the detent ball. Various options in this regard will occur to the worker of skill and are within the scope of the invention.

The diameter of handwheel 33 is such that, as is visible in FIG. 1, a portion of the handwheel protrudes via open end 24 above the uppermost extent of indexing mount 19 so as to be accessible by hand in use of the support 10. The overall arrangement is such that by rotating handwheel 33 discrete adjustments in the position of stem member 12 are effected. The outer periphery of handwheel 33 is knurled as shown in order to facilitate gripping and/or turning.

In the embodiment of the invention illustrated in the drawings the axes of pivoting about the respective shafts 23 and 36 are mutually perpendicular. This need not however be so. Other orientations of the pivot axis are of course possible within the scope of the invention.

The stem member 12 in the practical embodiment shown in the drawings includes two parts that are moveably securable one to the other such that the length of the stem member 12 is adjustable. This is achieved by virtue of the stem member being constructed from two sub-members 12a, 12b that are each of a rectangular, open-sided, channel cross-section as is evident from FIG. 2. Sub-member 12a is of smaller cross-section than sub-member 12b whereby sub-member 12a is receivable in a longitudinally slideable manner partially protruding from the upper end of sub-member 12b.

Sub-member 12a is formed with a longitudinally extending slot 43 along part of the length of the bottom of its channel shape. Sub-member 12b is formed including a pair of through-going apertures 44 via which a pair of bolts 46 may extend so as to protrude through the slot 43. The free ends of the bolts 46 are threadedly engageable with a nut 47 in the form of a plate having a pair of threaded apertures formed therein. The bolts 46 may be screwed into the nut 47 so as to secure the sub-members 12a and 12b to one another in a chosen position of relative longitudinal adjustment. This arrangement conveniently and cheaply provides for height adjustment of the support 10 of the invention.

One form of mounting of the support 10 is shown in FIG. 3.

In FIG. 3 the base 51 of a saddle-type, cruiser motorcycle seat 50 is formed approximately at its mid-point, between the saddle parts intended for use by a rider and pillion passenger, with a rectangular section socket 52.

The dimensions of socket 52 are such as to permit receipt therein of the indexing mount 19 of the support 10 according to the invention.

To this end the padded portion 53 of the seat includes formed therein, approximately mid-way along its length, a rectangular aperture 54 that is large enough to permit passage of the indexing mount 19 therethrough into the socket 52.

Indexing mount 19 includes secured at its lowermost portion a base plate 48 (FIG. 2). Socket 52 includes a similar base plate that is not visible in the drawings. The base plates are perforated by apertures that, when the indexing mount is inserted into the socket 52, are in register with one another. Set screws 56 may then be inserted from underneath the seat base 51 via the in-register apertures for the purpose of screwing the indexing mount 19 and the socket 52 one to the other. To this end the socket 52 is manufactured from a rigid material, as is the remainder of seat base 51.

As is also evident from FIG. 3 it is normal in use of the apparatus to secure a backrest 57 to the pad mounting 11, by means of further screws 58 passing through apertures formed in the plate-like pad mounting 11.

The result is the assembly shown in FIG. 4, in which the handwheel 33 is accessible via the aperture 54 and the screws 46 for adjusting the height of stem member 12 are accessible by reason of protrusion of stem member 12 above the material of padded seat part 53. In use the backrest support 10 of the invention is easy to adjust so as to accommodate differing sizes of rider and to permit variation of the riding position and the degree of spinal support for example as is desired during a long journey or when encountering a change in terrain. Overall the backrest support of the invention offers considerable versatility, compared with the prior art designs, at an economical price and in a manner that is simple to manufacture, install and operate.

1. A support for a backrest for a saddle-type seat, the support comprising a pad mounting secured to an in-use erect stem member a part of which is, at a pivot location remote from the pad mounting, pivotably secured to an indexing mount supporting a cam that is moveably engageable with the stem member, movement of the cam determining the part thereof that engages the stem member in order to cause the stem member and the indexing mount to pivot one relative to the other at the pivot location in adjustment of their relative translational positions.

2. A support according to claim 1 including a resiliently deformable biaser urging the stem member in a direction of movement that is opposed by engagement of the cam with the stem member.

3. A support according to claim 1 including a resiliently deformable biaser urging the stem member in a direction of movement that is opposed by engagement of the cam with the stem member; and a pivot bar, which protrudes from the stem member in order to define the pivot location, secured to the indexing mount and defining an axis about which the stem member pivots relative to the indexing mount, the resiliently deformable biaser including a spring that interconnects the stem member and the indexing mount so as resiliently to bias the stem member and the indexing mount one relative to the other.

4. A support according to claim 1 wherein the cam includes an exterior having formed thereon a series of flats separated from one another by edges.

5. A support according to claim 1 wherein the cam is rotatably secured to the indexing mount.

6. A support according to claim 1 wherein the cam is rotatably secured to the indexing mount; and including a camshaft having secured thereto the cam, the camshaft permitting rotatable securing of the cam to the indexing mount.

7. A support according to claim 1 wherein the cam is rotatably secured to the indexing mount; and including a camshaft having secured thereto the cam, the camshaft permitting rotatable securing of the cam to the indexing mount, wherein the camshaft has secured thereto an actuator member for moving the cam.

8. A support according to claim 7 wherein the actuator member protrudes beyond the extent of the indexing mount.

9. A support according to claim 7 wherein the actuator member is or includes a rotatable handwheel.

10. A support according to claim 7 including a resiliently deforrnable actuator biaser acting between the actuator and the indexing mount tending to urge the actuator towards a predetermined position; and wherein the actuator includes a detent arrangement that reacts pressure from the actuator baisser to provide surmountable resistance to movement of the actuator.

11. A support according to claim 1 wherein the stem member includes two parts that are moveably secured one to the other such that the length of the stem 20 member is adjustable.

12. A support according to claim 1 wherein the stem member includes two parts that are moveably secured one to the other such that the length of the stem member is adjustable, wherein the stem member includes two sub-members that are slideably engageable one with the other; and the stem member includes a fastener for fastening the sub-members together at any of a range of chosen relative positions.

13. A support according to claim 1 wherein the stem member includes two parts that are moveably secured one to the other such that the length of the stem member is adjustable, wherein the stem member includes two sub-members that are slideably engageable one with the other; and the stem member includes a fastener for fastening the sub-members together at any of a range of chosen relative positions, one of the sub-members including formed therein a slot and the other including an aperture for receiving a bolt, the bolt being capable of passing thorough the slot and receiving a nut on the side thereof remote from the aperture, for fastening the sub-members together at a chosen position of the bolt relative to the slot.

14. A support according to claim 1, including a backrest secured to the stem member.

15. A saddle-type seat having secured thereto a support according to claim 1.
